(19) United States
(12) Patent Application Publication
(10) Pub. No.: US 2026/0228172 A1
(43) Pub. Date: Aug. 6, 2026

(54) REPEATER SYMBOL ENCODING

(71) Applicant: NXP USA, Inc., AUSTIN, TX (US)

(72) Inventors: Ugo Mari, Pedara (IT); Steven Daniel, Gilbert, AZ (US)

(21) Appl. No.: 19/042,868

(22) Filed: Jan. 31, 2025

(51) Int. Cl. G06F 13/42; G06F 13/38

(52) U.S. Cl. CPC G06F 13/4282; G06F 13/382; G06F 2213/0042

(57) ABSTRACT

Embodiments of a repeater, an embedded Universal Serial Bus (eUSB) repeater, and a method of operating a repeater are disclosed. In an embodiment, a repeater includes an encoder configured to generate symbols based on data from multiple data sources and a transmitter modem configured to transmit information in the symbols over a repeater channel.

### BACKGROUND

In some architectures, communication devices are designed to repeat traffic between upstream facing ports and downstream facing ports, in either direction, by passing a communication stream through an intermediate data link. Such devices may be referred to as “Hybrid Repeaters” borrowing from embedded Universal Serial Bus 2 (eUSB2) terminology.

### SUMMARY

Embodiments of a repeater, an embedded Universal Serial Bus (eUSB) repeater, and a method of operating a repeater are disclosed. In an embodiment, a repeater includes an encoder configured to generate symbols based on data from multiple data sources and a transmitter modem configured to transmit information in the symbols over a repeater channel. Other embodiments are also disclosed.

In an embodiment, the data sources include a latency critical data source.

In an embodiment, the data sources include a first data source with a first data speed and a second data source with a second data speed, and the first data speed is different from the second data speed.

In an embodiment, the repeater further includes a framer configured to generate frames based on the symbols, where the transmitter modem is further configured to transmit the frames over the repeater channel.

In an embodiment, the repeater includes an embedded Universal Serial Bus (eUSB) repeater.

In an embodiment, the symbols have a size of four bits or twelve bits.

In an embodiment, the symbols include a burst symbol that is composed of four-bit symbols.

In an embodiment, the symbols include a clock adjustment symbol or a bus state symbol.

In an embodiment, the symbols include a non-repeating (NREP) symbol, a start of packet (SOP) symbol, an extra data (XDAT) symbol, or a non-action (NOP) symbol.

In an embodiment, an embedded Universal Serial Bus (eUSB) repeater includes an encoder configured to generate symbols based on data from a plurality of data sources and a transmitter modem configured to transmit information in the symbols over a repeater channel. The data sources include a latency critical data source, a first data source with a first data speed, and a second data source with a second data speed, and where the first data speed is different from the second data speed.

In an embodiment, the eUSB repeater further includes a framer configured to generate frames based on the symbols, where the transmitter modem is further configured to transmit the frames over the repeater channel.

In an embodiment, the symbols have a size of four bits or twelve bits.

In an embodiment, the symbols include a burst symbol that is composed of four-bit symbols.

In an embodiment, the symbols include a clock adjustment symbol or a bus state symbol.

In an embodiment, the symbols include a non-repeating (NREP) symbol, a start of packet (SOP) symbol, an extra data (XDAT) symbol, or a non-action (NOP) symbol.

In an embodiment, a method of operating a repeater includes using an encoder, generating symbols based on data from a plurality of data sources and using a transmitter modem, transmitting information in the symbols over a repeater channel.

In an embodiment, the data sources include a latency critical data source.

In an embodiment, the data sources include a first data source with a first data speed and a second data source with a second data speed, and where the first data speed is different from the second data speed.

In an embodiment, the method further includes frames based on the symbols, where transmitting the information in the symbols over the repeater channel includes transmitting the frames over the repeater channel.

In an embodiment, the symbols include a non-repeating (NREP) symbol, a start of packet (SOP) symbol, an extra data (XDAT) symbol, or a non-action (NOP) symbol.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts an example of a hybrid repeater re-timer system in accordance with an embodiment of the invention.

FIG. 2A and FIG. 2B show an example of a symbol encoding table that can be used by the hybrid repeater re-timer system depicted in FIG. 1.

FIG. 3A and FIG. 3B show an example of an NREP symbol encoding table that can be used by the hybrid repeater re-timer system depicted in FIG. 1.

FIG. 4A and FIG. 4B show an example of a repeater channel frame structure that can support the symbol encoding table in FIG. 2A and FIG. 2B and the symbol encoding table in FIG. 3A and FIG. 3B.

FIG. 5 depicts an example of a hybrid repeater re-timer system.

FIG. 6 shows example dynamic clock adjustment symbol information sent over a repeater channel to support eUSB latency requirement.

FIG. 7 shows example dynamic clock adjustment symbol information sent over a repeater channel to support eUSB latency requirement.

FIG. 8 is a process flow diagram of a method of operating a repeater in accordance with an embodiment of the invention.

FIG. 9 depicts an example of a repeater in accordance with an embodiment of the invention.

FIG. 10 depicts an example of a repeater system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

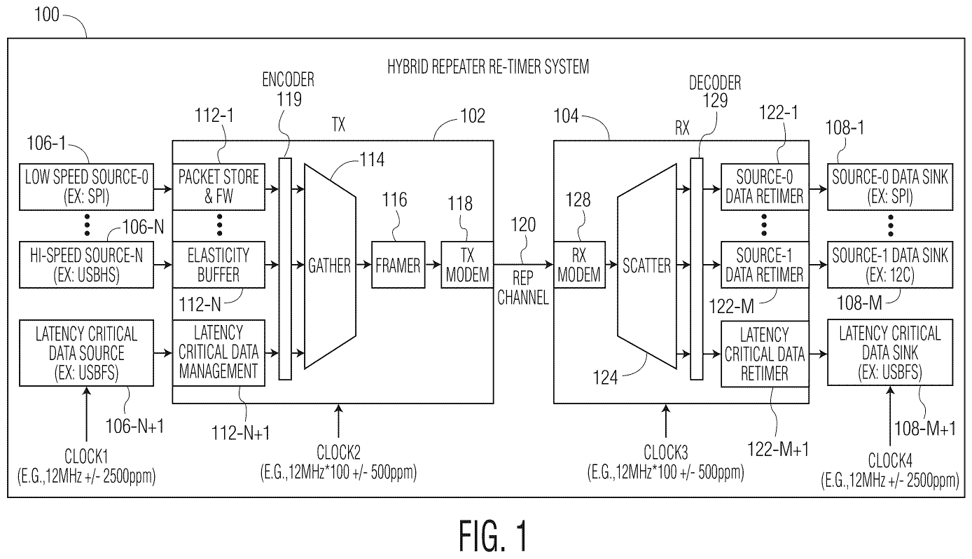

FIG. 1 depicts a hybrid repeater re-timer system 100 in accordance with an embodiment of the invention. In the embodiment depicted in FIG. 1, the hybrid repeater re-timer system 100 has a repeater channel 120 shared across multiple data sources and sinks. In the embodiment depicted in FIG. 1, the hybrid repeater re-timer system 100 includes a transmitter (TX) 102, a receiver (RX) 104, one or more data sources 106-1, . . . , 106-N+1, where N is a positive integer, and one or more data sinks 108-1, . . . , 108-M+1, where M is a positive integer. The hybrid repeater re-timer system 100 can be used in various applications, such as consumer or enterprise applications, medical applications, computer applications, and/or industrial applications. In the embodiment depicted in FIG. 1, the data sources 106-1, . . . , 106-N+1 include a low-speed data source (e.g., Serial Peripheral Interface (SPI)) 106-1, a high-speed data source (e.g., USB High Speed (USBHS)) 106-N, and a latency critical data source (e.g., USB Full Speed (USBFS)) 106-N+1, while the data sinks 108-1, . . . , 108-M+1 include a low-speed data source (e.g., SPI) 108-1, a high-speed data source (e.g., I2C) 108-M, and a latency critical data sink (e.g., USBFS) 108-M. In some embodiments, the hybrid repeater re-timer system 100 is a wired communications system, e.g., the repeater channel 120 is a wired channel. In some embodiments, the hybrid repeater re-timer system 100 is a wireless communications system, e.g., the repeater channel 120 is a wireless channel. The hybrid repeater re-timer system 100 may be fully or partially implemented as at least one integrated circuit (IC) device. In some embodiments, the transmitter (TX) 102 and the receiver (RX) 104 are located in separate substrates and are implemented as separate IC devices. Although the depicted hybrid repeater re-timer system 100 is shown in FIG. 1 with certain components and described with certain functionality herein, other embodiments of the hybrid repeater re-timer system 100 may include fewer or more components to implement the same, less, or more functionality. In addition, although the hybrid repeater re-timer system 100 is shown in FIG. 1 as being connected in a certain topology, the network topology of the hybrid repeater re-timer system 100 is not limited to the topology shown in FIG. 1. The hybrid repeater re-timer system 100 can be used in wireless and wired applications.

In the embodiment depicted in FIG. 1, the hybrid repeater re-timer system 100 can be used for aggregating multiple wired links to one shared connection which is the repeater channel, or for changing input transmission medium from passive wire to active logic, optical, wireless, or other connection, or for both of these and other reasons.

In some embodiments, the hybrid repeater re-timer system 100 is compatible with an eUSB protocol, which deals with a wide range of signaling conditions to be encoded. In some embodiments, an eUSB repeater at any given time operates in one of the two signaling modes: REP (Repeating) and NREP (Non-Repeating). REP mode is when the eUSB repeater is in Full-Speed packet Repeating state (L0), where packets are forwarded in both directions, one direction at a time (half-duplex), between upstream eD+/eD− and downstream eD+/eD−, with end to end signaling requirements defined by USB2.0 and eUSB2 specifications. REP mode can be timing critical for a hybrid re-timer device because of the latency and clock-tolerance requirement imposed by the USB2 specification. To satisfy REP timing requirements, timing-related information should be exchanged over the repeater channel 120 along with data-related information. NREP mode is the non-repeating signaling mode when the repeater channel 120 is in one of the following states:
Initialization during Port Reset, Configuration, Connect, Disconnect, USB Reset and Speed Negotiation;
Suspend, Resume and Remote Wake in L1 and L2 Suspend with additional XeSE1 and CM. Reset;
L0 while a control message or XeSE1 is being transmitted.
   In NREP mode, timing is not as critical as in NREP, since here the information is transmitted for control and status reporting purposes. On the other hand, NREP communication implies that several signaling states must be encoded because the same eD+/eD− value assumes different meaning depending on the current link state. In some phases, such as, during the port configuration handshake, NREP must also support full-duplex communication where one end of the repeater drives eD+(or eD−) and the other end drives eD−(or eD+) at the same time. Finally, as NREP deals with critical link state transitions, NREP symbol encoding should also be supported by some degree of redundant-encoding, thereby enabling detection of communication errors and fatal link state misalignments between the two sides of the channel.

State of the art implementation of a serial communication protocol between low-power devices exchanging multiple data streams over one bidirectional channel is typically based on half duplex regular frames exchange with predefined time-division slots filled with destination IDs and data as per the current traffic needs. Hybrid repeaters could be used for aggregating multiple wired links to one shared connection, which is the repeater channel, or for changing the input transmission medium from passive wire to active logic, optical, wireless, or another connection, or for both of these and other reasons. In these applications, the useful bandwidth capability of the channel becomes a key performance indicator of the device and of the system where the device operates. A pre-requisite to achieve high performance is that key data sources only consume as little bandwidth as possible on the channel.

eUSB is a key system peripheral as it is used in an extremely broad range of applications. Thanks to its versatility combined with its medium-speed bit rate, it is especially suited to support low-power communications modes of hybrid repeater systems. On the other hand, eUSB imposes challenging timing specification requirements on the channel such as maximum latency requirements, high clock tolerances, maximum frame jitter, etc. In some implementations, the eUSB low latency requirement may require that an eUSB slot is always allocated in the frame at a reserved position in each direction (no identification (ID) overhead) to allow fast channel reaction to an incoming eUSB packet, which could unpredictably come in either direction. As USB Full-Speed delivers 12 Megabyte (Mb)/s, the minimum eUSB bandwidth allocation requirement per frame is one symbol every 83.33 nanosecond (ns) in each direction. As the eUSB symbol permanently occupies two slots in a half-duplex frame with an 83.33 ns repetition period, it is important to keep the symbol size as limited as possible to maximize the frame efficiency, which is in contrast with the complex symbol encoding requirement for supporting both REP and NREP signals as described above.

In the embodiment depicted in FIG. 1, the hybrid repeater re-timer system 100 provides a complete and low-bandwidth (e.g., eUSB) Full-Speed symbol encoding solution, which can support (e.g., eUSB) Full-Speed signal retiming through an intermediate data link (hybrid repeater devices) that aggregates multiple data sources. The hybrid repeater re-timer system 100 has a broad range (e.g., serial link aggregation of multiple data rates) and caters to latency and jitter requirements of lower rate links. The hybrid repeater re-timer system 100 can be used in wireless and wired applications that require multiplexing and encoding of isochronous, bursty and latency sensitive data streams over a serial interface.

In the embodiment depicted in FIG. 1, the transmitter (TX) 102 includes one or more storage units 112-1, . . . , 112-N+1 that, for example, include a packet store and forward (FW) module 112-1, an elasticity buffer 112-N+1, a latency critical data management module 112-N+1, an optional encoder 119, a gather 114, a framer 116, and a TX modem 118. In some embodiments, at least one of the packet store and forward (FW) module 112-1, the elasticity buffer 112-N, the latency critical data management module 112-N+1, the encoder 119, the gather 114, the framer 116, and the TX modem 118 is implemented in analog, digital, and/or firmware circuity. In some embodiments, the encoder 119 is located between the storage units 112-1, . . . , 112-N+1 and the gather 114 or between the framer 116 and the TX modem. In an example operation, the packet store and forward (FW) module 112-1, the elasticity buffer 112-N, the latency critical data management module 112-N+1 receive data from the low-speed data source 106-1, the high-speed data source 106-N, and the latency critical data source 106-N+1, respectively, and send the received data to the gather 114 that aggregates the received data. The encoder 119 encodes the aggregated data to generate encoded data, which is processed by the framer 116, and modulated and outputted by the TX modem 118. In some embodiments, the gather 114 is implemented using a multiplexer or a sum unit.

In accordance with an embodiment of the invention, the encoder 119 is configured to generate symbols based on data from the data sources 106-1, . . . , 106-N+1, and the TX modem 118 is configured to transmit information in the symbols over a repeater channel 120. In some embodiments, the data sources include the latency critical data source 106-N+1. In some embodiments, the data sources 106-1, . . . , 106-N+1 include a first data source 106-1 with a first data speed and a second data source 106-N with a second data speed, and the first data speed is different from the second data speed. In some embodiments, the framer 116 is configured to generate frames based on the symbols, where the TX modem 118 is configured to transmit the frames over the repeater channel 120. In some embodiments, the transmitter (TX) 102 is a component of an embedded Universal Serial Bus (eUSB) repeater. In some embodiments, the symbols have a size of four bits or twelve bits. In some embodiments, the symbols include a burst symbol that is composed of four-bit symbols. In some embodiments, the symbols include a clock adjustment symbol or a bus state symbol. In some embodiments, the symbols include a non-repeating (NREP) symbol, a start of packet (SOP) symbol, an extra data (XDAT) symbol, or a non-action (NOP) symbol.

In the embodiment depicted in FIG. 1, the receiver (RX) 104 includes one or more retimer units 122-1, . . . , 122-M that can fully recover data, extract an embedded clock and retransmit a fresh copy of the data using a clean clock and for example, include a data retimer 122-1, a data retimer 122-M, a latency critical data retimer 122-M, a scatter 124, an optional decoder 129, and a RX modem 128. In some embodiments, at least one of the data retimer 122-1, the data retimer 122-M, the latency critical data retimer 122-M, the scatter 124, the decoder 129, and the RX modem 128 is implemented in analog, digital, and/or firmware circuity. In some embodiments, the decoder 129 is located between the RX modem 128 and the scatter 124. In an example operation, data received through the repeater channel 120 is demodulated by the RX modem 128, separated by the scatter 124, and decoded by the decoder 129, and the decoded data from the decoder 129 are processed by the data retimer 122-1, the data retimer 122-M, and the latency critical data retimer 122-M, and stored in the low-speed data source (e.g., SPI) 108-1, the high-speed data source (e.g., I2C) 108-M, and the latency critical data sink (e.g., USBFS) 108-M, respectively. In some embodiments, the scatter 124 is implemented using a demultiplexer.

In accordance with an embodiment of the invention, the RX modem 128 is configured to receive signals over the repeater channel 120 and the decoder 129 is configured to decode symbols based on the signals from the RX modem 128. In some embodiments, the receiver (RX) 104 is a component of an embedded Universal Serial Bus (eUSB) repeater. In some embodiments, the symbols have a size of four bits or twelve bits. In some embodiments, the symbols include a burst symbol that is composed of four-bit symbols. In some embodiments, the symbols include a clock adjustment symbol or a bus state symbol. In some embodiments, the symbols include a non-repeating (NREP) symbol, a start of packet (SOP) symbol, an extra data (XDAT) symbol, or a non-action (NOP) symbol.

In the embodiment depicted in FIG. 1, the hybrid repeater re-timer system 100 aims to maximize the channel frame efficiency and/or useful transported bandwidth by providing an ultra-compact, reliable, complete solution for (e.g., eUSB) Full-Speed symbol encoding over a hybrid repeater. In some embodiments, the hybrid repeater re-timer system 100 provides an eUSB Full-Speed symbol encoding solution with compact 4-bit symbols to handle the eUSB data packet repeating operation and extended 12-bit symbols, which are used in special cases, which also supports a clock adjustment mechanism that is used to meet the repeater latency requirement, which also supports the transmission of extra-data-sent-in frame (XDAT) or no-data-sent-in-frame (NOP) symbols that are used to prevent from overrun/underrun errors to occur during long-packet re-transmission due to the high clock tolerance margins allowed between the transmitter and the repeater (+/−2500 ppm at FS, +/−15000 ppm at LS), and which also supports a start of packet (SOP) mechanism to achieve a constant propagation delay through the repeater and also meet the SOF max-jitter requirement, which also supports the NREP signaling mode with redundant symbol encoding for safe link state transitions, which also supports the exchange of state alignment messages between the two sides of the hybrid repeater, and which also supports transmission of test and debug controls with room for future extension. In this embodiment, the input clock Clock2=(12 million hertz (MHz)*100)+/−500 parts per million (ppm) of the TX 102 and the input clock Clock3=(12 MHz*100)+/−500ppm of the RX 104 are chosen with a multiplication factor of 100 with respect to the USB Full-Speed data rate (e.g., the clock Clock2=12 MHz+/−2500 ppm of the TX 102 and the clock Clock3=12 MHz+/−2500 ppm of the RX 104 are chosen). Lower multiplication factors may be used. In this embodiment, Clock2 and Clock3 run at higher speed with respect to the USB Full-Speed data rate for allowing the repeater to perform all the necessary steps within one bit period, and are also an integer multiple of the data rate to be in line with the USB frequency requirement. Moreover, Clock2 and Clock3 frequency must be high enough to measure and apply the clock adjustment factor with a precision compatible with the max jitter requirement. The indicated +/−500 ppm clock frequency tolerance is chosen in case the repeater system 100 can also support the USB High-Speed data rates. Otherwise, if limited to Full-Speed requirement, Clock2 and Clock3 clock frequency precision can be relaxed to +/−2500 ppm.

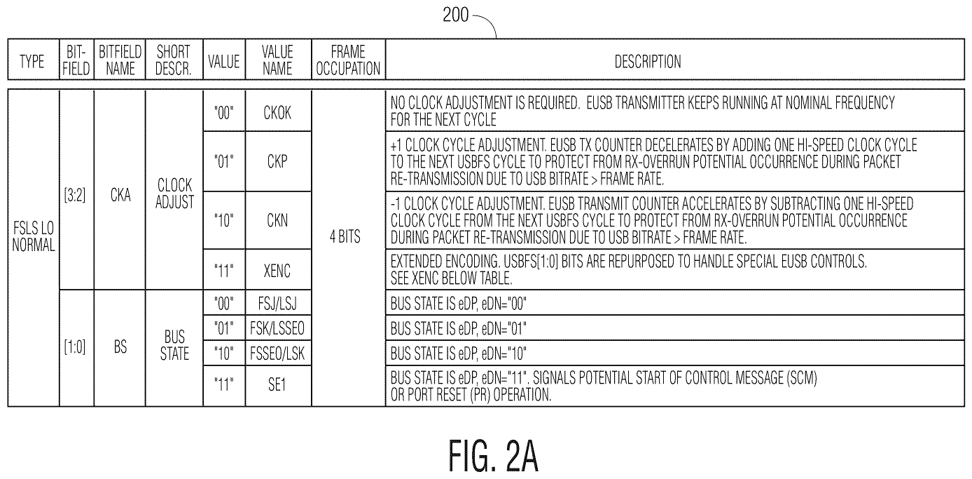

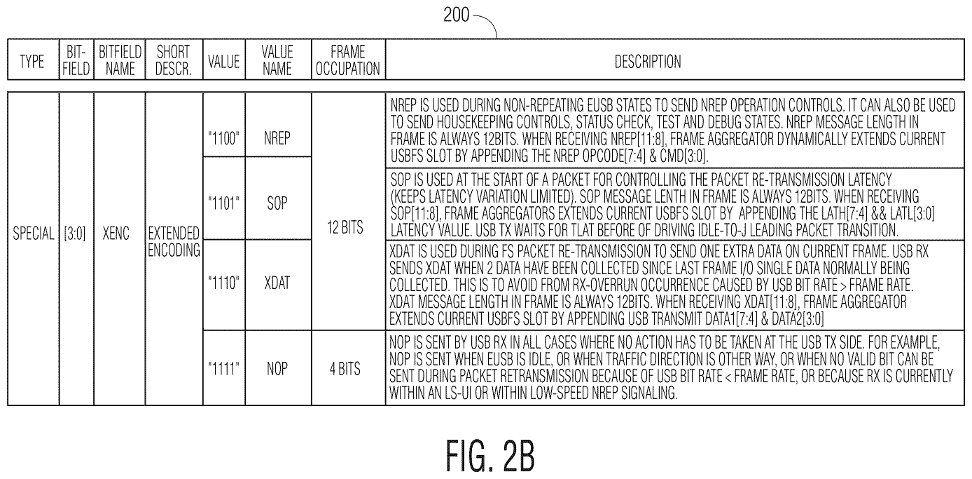

FIG. 2A and FIG. 2B show an example of a symbol encoding table 200 that can be used by the hybrid repeater re-timer system 100 depicted in FIG. 1. As shown in FIG. 2A and FIG. 2B, the symbol encoding table 200 contains columns of data type, bit field (size), bit field name, short description, value, value name, frame occupation and description.

As shown in FIG. 2A, full-speed low-speed (FSLS) L0 Normal data type has bitfields [3:2] and [1:0]. Bitfield [3: 2] has a bitfield name of CKA, which contains clock adjustment information. In an example, CKA has a value of “00,” with a value name of CKOK, which indicates that no clock adjustment is required at the re-transmitting end of the repeater and that the eUSB transmitter shall keep running at nominal frequency for the next cycle. In an example, CKA has a value of “01,” with a value name of CKP (positive clock adjustment), which indicates +1 clock cycle adjustment is required at the re-transmitting end of the repeater and that the eUSB TX counter shall decelerate by adding one high-speed clock cycle to the next USBFS cycle to protect from Tx-Underrun potential occurrence during packet re-transmission due to USB bitrate <Frame rate. In an example, CKA has a value of “10,” with a value name of CKN (negative clock adjustment), which indicates −1 clock cycle adjustment is required at the re-transmitting end of the repeater and that the eUSB transmit counter shall accelerate by subtracting one high-speed clock cycle from the next USBFS cycle to protect from Rx-Overrun potential occurrence during packet re-transmission due to USB bitrate >Frame rate. In an example, CKA has a value of “11,” with a value name of XENC (extended encoding), which indicates that USBFS[1:0] bits are repurposed to handle special eUSB controls. Bitfield [1:0] has a bitfield name of BS (bus state), which contains bus state information. In an example, BS has a value of “00,” with a value name of FSJ/LSJ, which indicates that bus state is eDP, eDN=“00.” (eDP: the positive data terminal, eDN: the negative data terminal). When BS has a value of “01,” with a value name of FSK/LSSE0, which indicates that bus state is eDP, eDN=“01.” In an example, BS has a value of “10,” with a value name of FSSE0/LSK, which indicates that bus state is eDP, eDN=“10.” In an example, BS has a value of “11,” with a value name of SE1 (single-ended-one), which indicates that bus state is eDP, eDN=“11,” which signals potential Start of Control Message (SCM) or Port Reset (PR) operation.

As shown in FIG. 2B, a special data type, which is characterized by having symbol's bitfield [3:2]=“11” (XENC), is used to handle special cases when in data packet repeating mode, and is also used to handle the low-speed and low-bandwidth eUSB state transition protocol when in NREP signaling mode. Bitfield [3:0] has a bitfield name of XENC, which contains extended encoding information. In an example, XENC has a value of “1100” with a value name of NREP, which is used during Non-Repeating eUSB states to send NREP operation controls. It can also be used to send housekeeping messages, status checks, test and debug controls. NREP message length in a frame is always 12 bits. In an example, when receiving NREP[11:8], a frame aggregator dynamically extends current USBFS slot by appending the NREP Operation Code (OPCODE) [7:4] & Command Prompt (CMD) [3:0] (burst3 command in the symbol encoding table 200).

In an example, XENC has a value of “1101,” with a value name of SOP, which is used at the start of a packet for controlling the packet re-transmission latency (i.e., keeps latency variation limited). SOP message length in frame is always 12 bits. In an example, when receiving the SOP[11:8] symbol, the frame aggregators extends the current USBFS slot by appending the latency value high LATH [7:4] and the latency value low LATL [3:0] forming the TLAT[7:0] latency value that the eUSB re-transmitter shall count before starting packet re-transmission to achieve a fixed packet propagation delay through the repeater.

In an example, XENC has a value of “1110,” with a value name of XDAT, which is used during FS packet re-transmission to send one extra data on current frame. A USB RX sends XDAT when 2 data have been collected since last frame input/output (I/O) single data normally being collected, which is to avoid from Rx-Overrun occurrence caused by USB bit rate >Frame rate. XDAT message length in frame is always 12 bits. In an example, when receiving XDAT[11:8], a frame aggregator extends current USBFS slot by appending USB transmit DATA1[7:4] & DATA2[3:0].

In an example, XENC has a value of “1111,” with a value name of NOP, which is sent by a USB RX in all cases where no action has to be taken at the USB TX side. For example, NOP is sent when eUSB is idle, or when traffic direction is other way, or when no valid bit can be sent during packet retransmission because of USB bit rate <Frame rate, or because the RX is currently within an LS-UI or within low-speed NREP signaling.

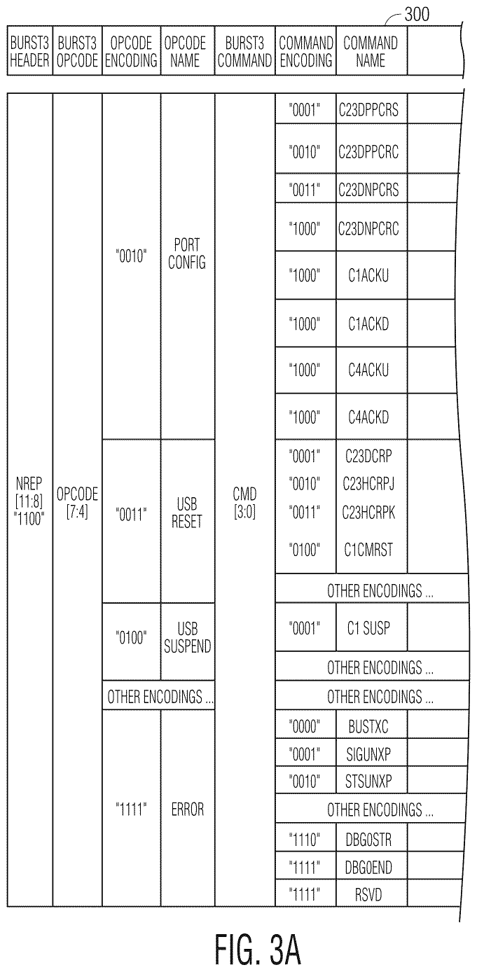

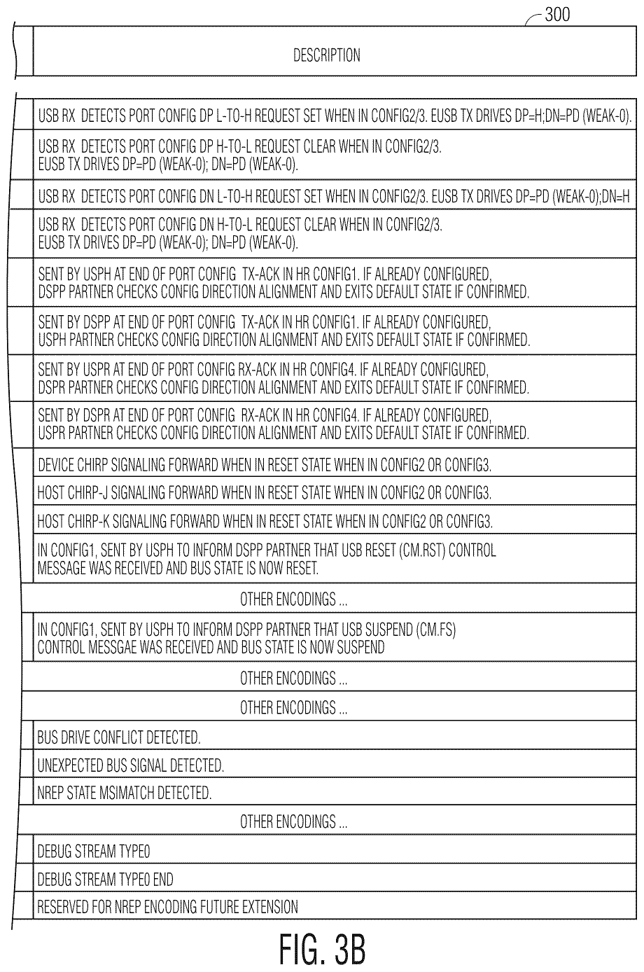

FIG. 3A and FIG. 3B show an example of an NREP symbol encoding table 300 that can be used by the hybrid repeater re-timer system 100 depicted in FIG. 1. As shown in FIG. 3A and FIG. 3B, the NREP symbol encoding table 300 contains columns of burst header, burst opcode, opcode encoding, opcode name, command encoding, command name, and description.

NREP [11:8], “1100,” burst header has opcode [7:4], which has opcode encoding of “0010,” “0011,” “0100,” other encodings, and “1111.”

Opcode encoding “0010” has an opcode name of port config, which may contain port configuration information. In an example, port config has a command encoding of “0001,” with a command name of C23DPPCRS, which indicates that the USB RX detects port config DP L-to-H request set when in Config2/3 and that eUSB TX drives DP=H; DN=PD (weak−0).

In an example, port config has a command encoding of “0010,” with a command name of C23DPPCRC, which indicates that the USB RX detects port config DP H-to-L request clear when in Config2/3 and that EUSB TX drives DP=PD (weak−0); DN=PD (weak−0).

In an example, port config has a command encoding of “0011,” with a command name of C23DNPCRS, which indicates that the USB RX detects port config DN L-to-H request set when in Config2/3 and that eUSB TX drives DP=PD (weak-0); DN=H.

In an example, port config has a command encoding of “1000,” with a command name of C23DNPCRC, which indicates that the USB RX detects port config DN H-to-L request clear when in Config2/3 and that eUSB TX drives DP=PD (weak-0); DN=PD (weak-0).

USPH, DSPP, USPR, DSPR are four port types that behave differently in the possible configurations of an eUSB hybrid repeater. In an example, port config has a command encoding of “1000,” with a command name of C1ACKU, which is sent by the USPH at end of port config tx-ack in HR Config1. If already configured, a DSPP partner checks config direction alignment and exits Default state if confirmed.

In an example, port config has a command encoding of “1000,” with a command name of C1ACKD, which is sent by the DSPP at end of port config tx-ack in HR Config1. If already configured, a USPH partner checks config direction alignment and exits Default state if confirmed.

In an example, port config has a command encoding of “1000,” with a command name of C4ACKU, which is sent by a USPR at end of port config rx-ack in HR Config4. If already configured, a DSPR partner checks config direction alignment and exits Default state if confirmed.

In an example, port config has a command encoding of “1000,” with a command name of C4ACKD, which is sent by a DSPR at end of port config rx-ack in HR Config4. If already configured, a USPR partner checks config direction alignment and exits Default state if confirmed.

Opcode encoding “0011” has an opcode name of USB reset, which may contain USB reset information. When USB reset has a command encoding of “0001,” with a command name of C23DCRP, which indicates Device Chirp signaling forward when in Reset State when in Config2 or Config3.

In an example, USB reset has a command encoding of “0010,” with a command name of C23HCRPJ, which indicates Host Chirp-J signaling forward when in Reset State when in Config2 or Config3.

In an example, USB reset has a command encoding of “0011,” with a command name of C23HCRPK, which indicates Host Chirp-K signaling forward when in Reset State when in Config2 or Config3.

In an example, USB reset has a command encoding of “0100,” with a command name of C1CMRST, which In Config1, sent by USPH to inform DSPP partner that USB Reset (CM. RST) control message was received and Bus state is now RESET.

Opcode encoding “0100” has an opcode name of USB suspend, which may contain USB suspend information. In an example, USB suspend has a command encoding of “0001,” with a command name of C1 SUSP (suspend, a USB power saving state), which in Config1, sent by USPH to inform DSPP partner that USB Suspend (CM. FS) control message was received and Bus state is now SUSPEND.

Opcode encoding “1111” has an opcode name of Error, which may contain error information. When Error has a command encoding of “0000,” with a command name of BUSTXC, which indicates that a bus drive conflict is detected.

In an example, Error has a command encoding of “0001,” with a command name of SIGUNXP, which indicates that an unexpected bus signal is detected.

In an example, Error has a command encoding of “0010,” with a command name of STSUNXP, which indicates that an NREP state mismatch is detected.

In an example, Error has a command encoding of “1110,” with a command name of DBG0STR, which indicates DEBUG stream type0 start.

In an example, Error has a command encoding of “1111,” with a command name of DBG0END, which indicates DEBUG stream type0 end.

In an example, Error has a command encoding of “1111,” with a command name of RSVD, which is reserved for NREP encoding future extension.

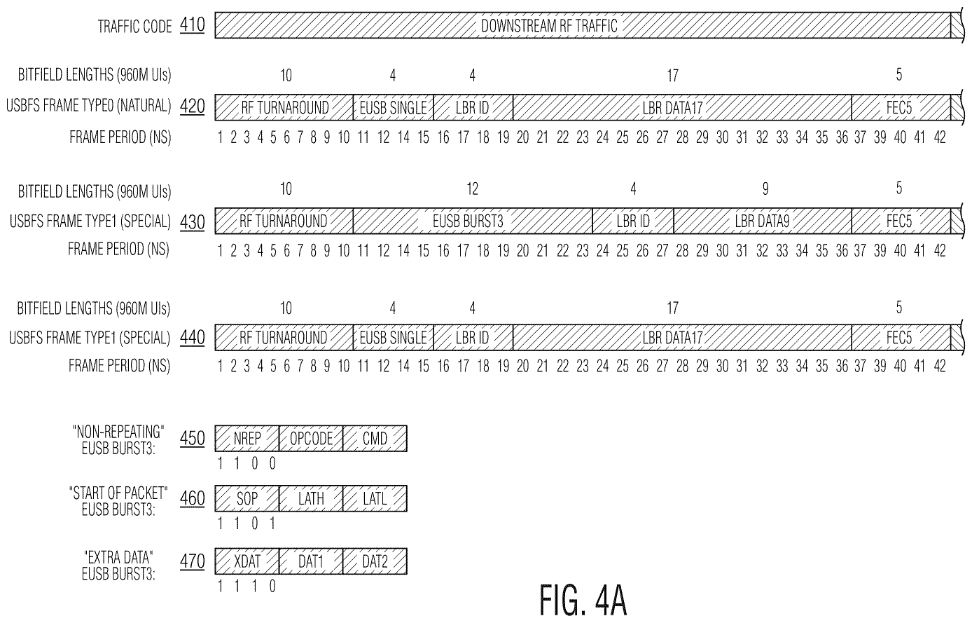

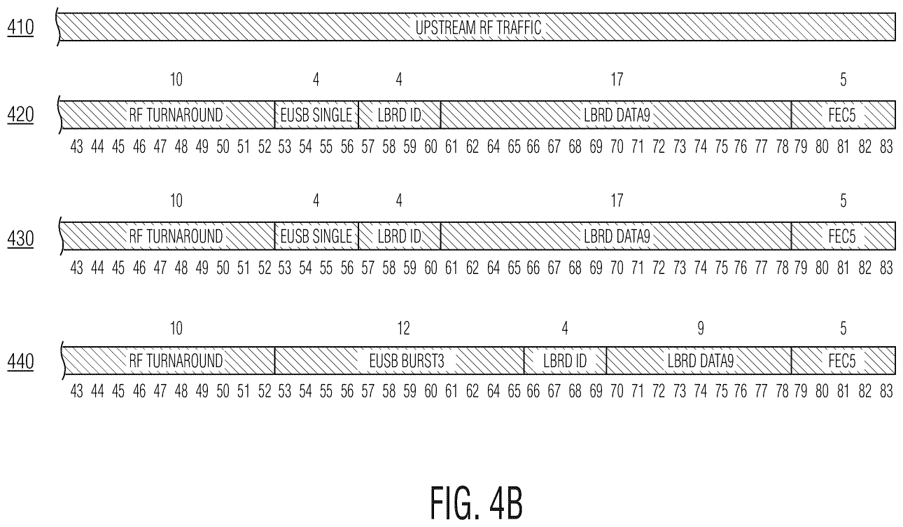

FIG. 4A and FIG. 4B show an example of a repeater channel frame structure 400 that can support the symbol encoding table 200 in FIG. 2A and FIG. 2B and the symbol encoding table 300 in FIG. 3A and FIG. 3B. As shown in FIG. 4A and FIG. 4B, the repeater channel frame structure 400 includes traffic direction (e.g., to indicate downstream or upstream traffic) 410, USBFS frame type0 420, USBFS frame type1 430, USBFS frame type1 440, “Non-Repeating” eUSB burst3 450, “Start of Packet” eUSB burst3 460, and “Extra Data” eUSB burst3 470. In this structure, the default USB symbol sent for normal USB operation is 4-bits. In special cases, a 12-bit symbol is sent in place of the default 4-bit symbol. The 12-bit “burst3” symbol is composed of three 4 bit symbols which are sent back-to-back on the frame. There are 3 types of special 12-bit bursty symbols described in the encoding table: XDAT, NREP, and SOP which are sent for special purposes. Special symbols are identified by the header 4 bit symbol starting with “11” and the following 2-bits are different from “00.” On the system side, the design block in charge of forming and sending the frame must detect the special symbol from the header and consequently dynamically extend the USB slot for 8-bit more locations, and reschedule what is planned after an eUSB standard symbol and replaced by an eUSB extended symbol in a later slot opportunity, even within the same frame if possible.

Another option that does not need dynamic frame-space re-allocation when detecting the special symbols, thus simplifying the Framer block, is to create dedicated data IDs for XDAT, NREP and SOP, and send these eUSB special IDs followed by their associated 8 bit data in the NON-eUSB section of the frame like for the other Low bit rate serial data.

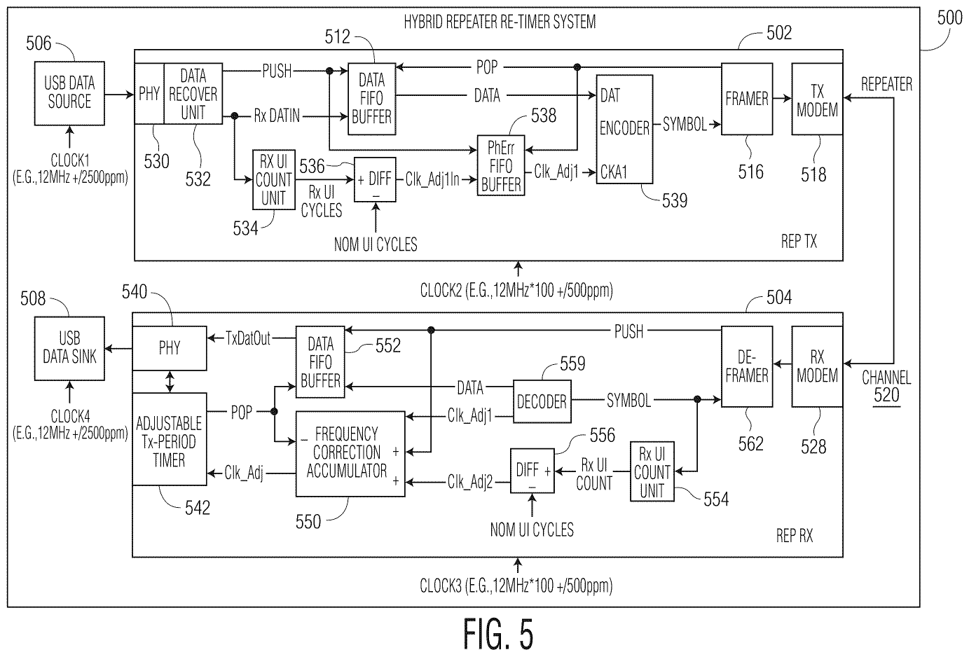

FIG. 5 depicts an example of a hybrid repeater re-timer system 500 that can be used to perform symbol encoding/decoding. The hybrid repeater re-timer system 500 depicted in FIG. 5 is an embodiment of the hybrid repeater re-timer system 100 depicted in FIG. 1. However, the hybrid repeater re-timer system 100 depicted in FIG. 1 is not limited to the embodiment depicted in FIG. 5. In some embodiments, symmetric embodiment is required to support repeater communication in the upstream direction.

In the embodiment depicted in FIG. 5, the hybrid repeater re-timer system 500 has a repeater channel 520 (e.g., a single serial link) between a data source (e.g., a USB data source) 506 and a data sink (e.g., a USB data sink) 508. In some embodiments, the hybrid repeater re-timer system 500 has one repeater channel (e.g., the repeater channel 520) between multiple data sources and multiple critical sinks. In the embodiment depicted in FIG. 5, the hybrid repeater re-timer system 500 includes a transmitter (TX) 502 and a receiver (RX) 504. The hybrid repeater re-timer system 500 may be fully or partially implemented as at least one integrated circuit (IC) device. In some embodiments, the transmitter (TX) 502 and the receiver (RX) 504 are located in separate substrates and are implemented as separate IC devices.

In the embodiment depicted in FIG. 5, the transmitter (TX) 502 includes a data recover unit 532, a PHY unit 530, a data First-in First-out (FIFO) buffer 512, an encoder 539, an RX Unit Interval (UI) counter unit 534, a difference calculator 536, a phase error FIFO buffer 538, a framer 516, and a TX modem 518. In some embodiments, at least one of the data recover unit 532, the data FIFO buffer 512, the encoder 539, the RX UI unit 534, the difference calculator 536, the phase error FIFO buffer 538, the framer 516, and the TX modem 518 is implemented in digital, and/or firmware circuity. In some embodiments, the PHY unit 530 is implemented in analog, digital, and/or firmware circuity. In some embodiments, the encoder 539 is configured to generate symbols based on data from the data source 506, and the TX modem 518 is configured to transmit information in the symbols over the repeater channel 520. In some embodiments, the framer 516 is configured to generate frames based on the symbols, where the TX modem 518 is configured to transmit the frames over the repeater channel 520. In some embodiments, the transmitter (TX) 502 is a component of an embedded Universal Serial Bus (eUSB) repeater.

In accordance with an embodiment of the invention, the encoder 539 is configured to generate symbols based on data from the latency critical data source 506, and the TX modem 518 is configured to transmit information in the symbols over a repeater channel 520. In some embodiments, the framer 516 is configured to generate frames based on the symbols, where the TX modem 518 is configured to transmit the frames over the repeater channel 520. In some embodiments, the transmitter (TX) 502 is a component of an embedded Universal Serial Bus (eUSB) repeater. In some embodiments, the symbols have a size of four bits or twelve bits. In some embodiments, the symbols include a burst symbol that is composed of four-bit symbols. In some embodiments, the symbols include a clock adjustment symbol or a bus state symbol. In some embodiments, the symbols include a non-repeating (NREP) symbol, a start of packet (SOP) symbol, an extra data (XDAT) symbol, or a non-action (NOP) symbol.

In an example operation of the transmitter (TX) 502, based on signals from the data source 506 (e.g., a latency critical data source, such as, USBFS) received through the PHY unit 530, the data recover unit 532 generates a push signal and a RX Datin signal, which are inputted into the data FIFO buffer 512, the RX UI count unit 534, and/or the phase error FIFO buffer 538. The data source 506 operates under a clock signal Clock1 and the transmitter (TX) 502 operates under a clock signal Clock2. Based on the RX Datin signal, the RX UI count unit 534 generates RX UI cycles, which are inputted into the difference calculator 536. The difference calculator 536 compares the RX UI cycles with Network Operations Management (NOM) UI cycles to generate a phase error signal Clk_AdjIn, which is inputted into the phase error FIFO buffer 538. Based on the push signal and the RX Datin signal, the data FIFO buffer 512 generates a Pop signal that is inputted into the phase error FIFO buffer 538, and a data signal, which is inputted into the encoder 539. Based on the Pop signal, the push signal, the phase error signal Clk_AdjIn, the phase error FIFO buffer 538 generates a clock adjustment signal Clk_Adj1, which is inputted into the encoder 539. Based on the data signal and the clock adjustment signal Clk_Adj1, the encoder 539 generates symbols, which are inputted into the framer 516. Based on the symbols and the Pop signal, the TX modem generates output signals to be transmitted through the repeater channel 520.

In the embodiment depicted in FIG. 5, the receiver (RX) 504 includes an adjustable TX-period timer 542, a PHY unit 540, a frequency correction accumulator 550, a data FIFO buffer 552, a decoder 559, an RX UI count unit 554, a difference calculator 556, a de-framer 562, and a RX modem 528. In some embodiments, at least one of the adjustable TX-period timer 542, the frequency correction accumulator 550, the data FIFO buffer 552, the decoder 559, the RX UI count unit 554, the difference calculator 556, the de-framer 562, and the RX modem 528 is implemented in digital and/or firmware circuity. In some embodiments, the PHY unit 540 is implemented in analog, digital, and/or firmware circuity. In some embodiments, the RX modem 528 is configured to receive signals over the repeater channel 520 and the decoder 559 is configured to decode symbols based on the signals from the RX modem 528. In some embodiments, the receiver (RX) 504 is a component of an embedded Universal Serial Bus (eUSB) repeater. In some embodiments, the symbols have a size of four bits or twelve bits. In some embodiments, the symbols include a burst symbol that is composed of four-bit symbols. In some embodiments, the symbols include a clock adjustment symbol or a bus state symbol. In some embodiments, the symbols include a non-repeating (NREP) symbol, a start of packet (SOP) symbol, an extra data (XDAT) symbol, or a non-action (NOP) symbol.

In accordance with an embodiment of the invention, the RX modem 528 is configured to receive signals over the repeater channel 520 and the decoder 559 is configured to decode symbols based on the signals from the RX modem 528. In some embodiments, the receiver (RX) 504 is a component of an embedded Universal Serial Bus (eUSB) repeater. In some embodiments, the symbols have a size of four bits or twelve bits. In some embodiments, the symbols include a burst symbol that is composed of four-bit symbols. In some embodiments, the symbols include a clock adjustment symbol or a bus state symbol. In some embodiments, the symbols include a non-repeating (NREP) symbol, a start of packet (SOP) symbol, an extra data (XDAT) symbol, or a non-action (NOP) symbol.

In an example operation of the receiver (RX) 504, the RX modem 528 processes signals received from the TX modem 518 through the repeater channel 520 and outputs processed signals to the de-framer 562, which generates extracted symbols and a Push signal. The decoder 559 decodes the symbols to generate a TX Datin signal and a frequency correction factor CLK_adjust1. The RX UI Count unit 554 measures the symbol UI period and the difference calculator 556 compares the measured symbol period with the nominal symbol period to generate a frequency correction factor CLK_adjust2. The Clk_adjust1 and Clk_adjust2 frequency correction factors are accumulated into the frequency correction accumulator 550, which combines the two frequency correction factors by their algebraic sum. Based on a Pop signal from the adjustable TX-period timer 542, the frequency correction accumulator 550 gets decremented by the same quantity applied by the adjustable TX-period timer 542. The data FIFO buffer 552 generates a TXDATOUT signal based on the Pop signal, the Push signal, and the TX Datin signal. The adjustable TX-period timer 542 and the data FIFO buffer 552 transmit signals to the data sink 508 (e.g., a latency critical data sink, such as, USBFS) through the PHY unit 540. The data sink 508 operates under a clock signal Clock4 and the receiver (RX) 504 operates under a clock signal Clock3.

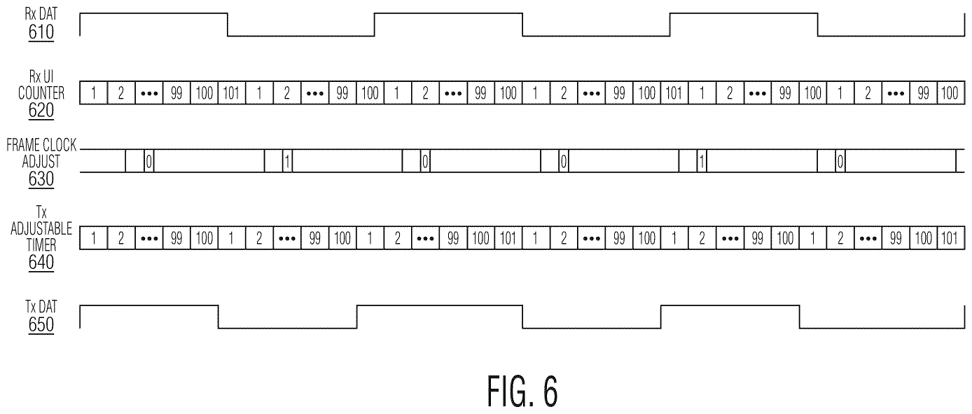

FIG. 6 shows example dynamic clock adjustment symbol information sent over the repeater channel 520 to support eUSB latency requirement. As shown in FIG. 6, the dynamic clock adjustment symbol information includes RX Data (RX Dat) 610, RX UI counter 620, Frame clock Adjustment 630, Tx Adjustable Timer 640, and TX Data (TX Dat) 650. As shown in FIG. 6, the Tx Adjustable Timer 640 increases by one or stays the same with respect to the RX UI counter 620, based on the value of the Frame clock Adjustment 630, which results in the frequency correction (i.e., shifting of falling edges and rising edges) of the TX Data (TX Dat) 650 that is output from the receiver (RX) 504 with respect to the RX Data (RX Dat) 610 that is received at the receiver (RX) 504. For example, frequency tracking exemplification may have USBFS UI=83.33 ns, Rep1freq=Rep2freq, USBFS vs Rep1freq=−3333 ppm.

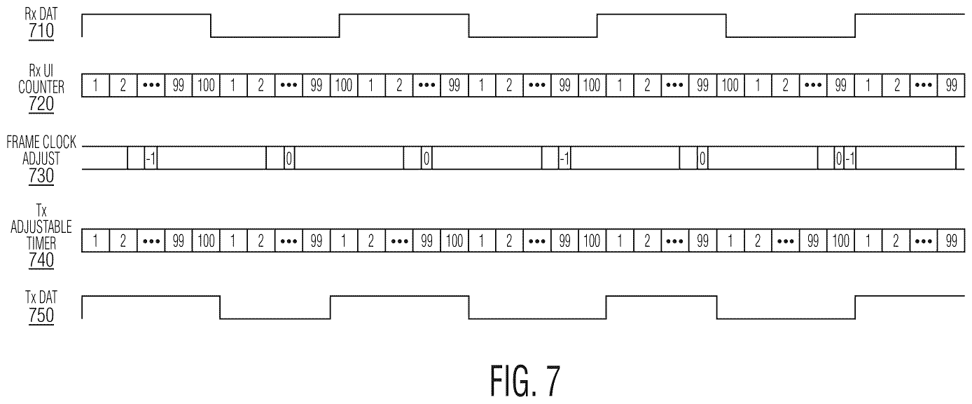

FIG. 7 shows example dynamic clock adjustment symbol information sent over the repeater channel 520 to support eUSB latency requirement. As shown in FIG. 7, the dynamic clock adjustment symbol information includes RX Data (RX Dat) 710, RX UI counter 720, Frame clock Adjustment 730, Tx Adjustable Timer 740, and TX Data (TX Dat) 750. In the example shown in FIG. 7, the USB bit rate is faster than frame repetition frequency due to eUSB input clock tolerance margin, clock adjustment extra data is sent (XDAT) as the last symbol. As shown in FIG. 7, the Tx Adjustable Timer 740 decreases by one or stays the same with respect to the RX UI counter 720, based on the value of the Frame clock Adjustment 730, which results in the frequency correction (i.e., shifting of falling edges and rising edges) of the TX Data (TX Dat) 750 that is output from the receiver (RX) 504 with respect to the RX Data (RX Dat) 710 that is received at the receiver (RX) 504. For example, frequency tracking exemplification may have USBFS UI=83.33 ns, Rep1freq=Rep2freq, USBFS vs Rep1freq=+3333 ppm.

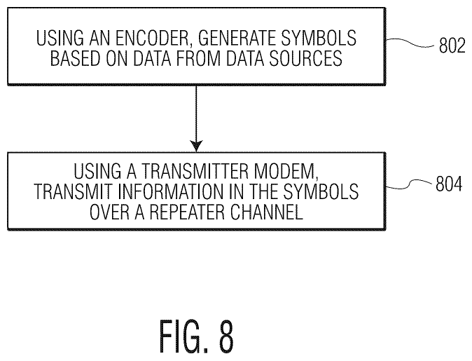

FIG. 8 is a process flow diagram of a method of operating a repeater in accordance with an embodiment of the invention. At block 802, using an encoder, symbols are generating based on data from multiple data sources. At block 804, using a transmitter modem, information in the symbols is transmitted over a repeater channel. In some embodiments, the data sources includes a latency critical data source. In some embodiments, the data sources include a first data source with a first data speed and a second data source with a second data speed, and the first data speed is different from the second data speed. In some embodiments, the method further includes generating frames based on the symbols, where transmitting the information in the symbols over the repeater channel includes transmitting the frames over the repeater channel. In some embodiments, the symbols include a non-repeating (NREP) symbol, a start of packet (SOP) symbol, an extra data (XDAT) symbol, or a non-action (NOP) symbol. The repeater may be the same as or similar to the transmitter (TX) 102 depicted in FIG. 1, the hybrid repeater re-timer system 100 depicted in FIG. 1, the transmitter (TX) 502 depicted in FIG. 5, and/or the hybrid repeater re-timer system 500 depicted in FIG. 5. The encoder may be the same as or similar to the encoder 119 depicted in FIG. 1 and/or the encoder 539 depicted in FIG. 5. The transmitter modem may be the same as or similar to the transmitter modem 118 depicted in FIG. 1 and/or the transmitter modem 518 depicted in FIG. 5.

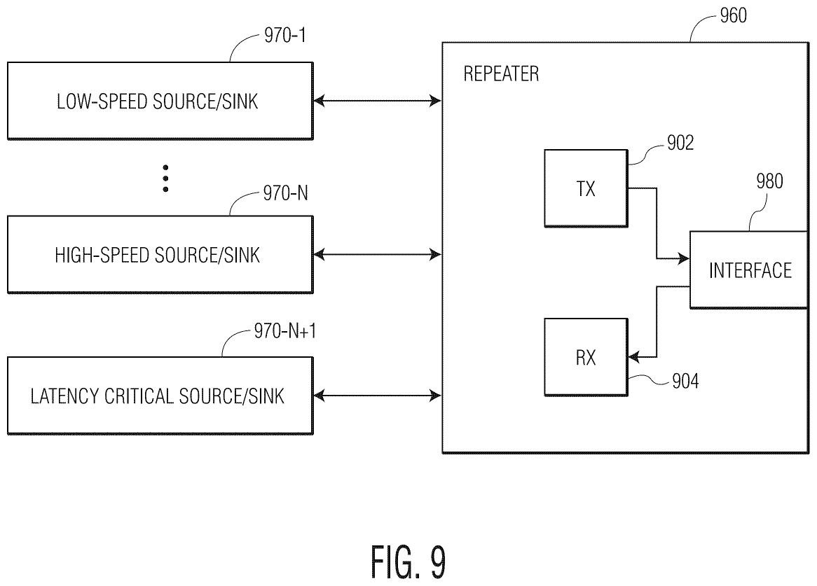

FIG. 9 depicts an example of a repeater 960 in accordance with an embodiment of the invention. In the embodiment depicted in FIG. 9, the repeater 960 includes a transmitter (TX) 902, a receiver (RX) 904, and an interface 980, is connected to one or more data sources and/or sinks 970-1, . . . , 970-N+1, where N is a positive integer, through one or more links (e.g., a serial communications interface, such as, an USB interface (e.g., an eUSB interface)). For example, the TX 902 depicted in FIG. 9 may be an embodiment of the TX 102 depicted in FIG. 1 and/or the TX 502 depicted in FIG. 5. In an example, the RX 904 depicted in FIG. 9 may be an embodiment of the RX 104 depicted in FIG. 1 and/or the RX 504 depicted in FIG. 5. In some embodiments, the data sources and/or sinks 970-1, . . . , 970-N+1 include a low-speed data source/sink (e.g., Serial Peripheral Interface (SPI)) 970-1, a high-speed data source/sink (e.g., USB High Speed (USBHS)) 970-N, and a latency critical data source/sink (e.g., USB Full Speed (USBFS)) 970-N+1. The repeater 960 may be fully or partially implemented as an integrated circuit (IC) device. In the embodiment depicted in FIG. 9, the transmitter (TX) 902 and the receiver (RX) 904 are located in the same substrate and the repeater 960 is implemented as one IC device (e.g., a system on chip (SOC)) for bi-directional (downstream and upstream) communications. Although the depicted repeater 960 is shown in FIG. 9 with certain components and described with certain functionality herein, other embodiments of the repeater 960 may include fewer or more components to implement the same, less, or more functionality. In addition, although the repeater 960 is shown in FIG. 9 as being connected in a certain topology, the network topology of the repeater 960 is not limited to the topology shown in FIG. 9.

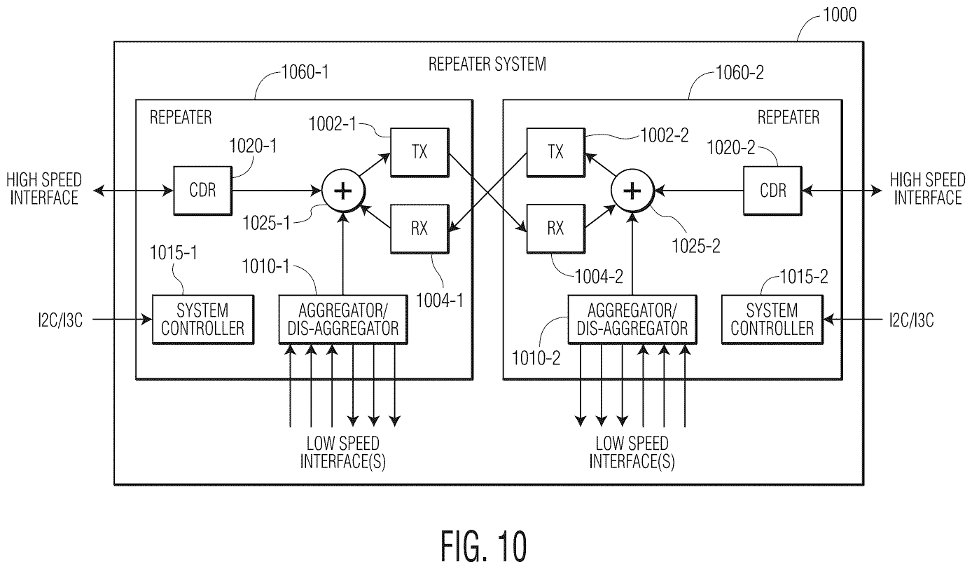

FIG. 10 depicts an example of a repeater system 1000 in accordance with an embodiment of the invention. In the embodiment depicted in FIG. 10, the repeater system 1000 includes a first repeater 1060-1 that includes a transmitter (TX) 1002-1, a receiver (RX) 1004-1, an aggregator/dis-aggregator 1010-1 that may be connected to one or more low speed interfaces (e.g., Universal Asynchronous Receiver/Transmitter (UART), Serial Wire Debug (SWD), or I2C), a system controller 1015-1 that may be connected to I2C/I3C interface, a Clock Data Recovery (CDR) 1020-1 that may be connected to a high speed interface, and a switch/multiplexer 1025-1 and a second repeater 1060-2 that includes a transmitter (TX) 1002-2, a receiver (RX) 1004-2, an aggregator/dis-aggregator 1010-2 that may be connected to one or more low speed interfaces (e.g., Universal Asynchronous Receiver/Transmitter (UART), Serial Wire Debug (SWD), or I2C), a system controller 1015-2 that may be connected to I2C/I3C interface, a Clock Data Recovery (CDR) 1020-2 that may be connected to a high speed interface, and a switch/multiplexer 1025-2. In the embodiment depicted in FIG. 10, the repeater system 1000 is half-duplex, the TX 1002-1 communicates with the RX 1004-2 and the TX 1002-2 communicates with the RX 1004-1 over a serial channel (e.g., tying all four of the ports (2 TX and 2 RX) together) to implement both downstream and upstream traffic. The repeater system 1000 may be an embodiment of the hybrid repeater re-timer system 100 depicted in FIG. 1 and/or the hybrid repeater re-timer system 500 depicted in FIG. 5. For example, the TXs 1002-1, 1002-2 depicted in FIG. 10 may be an embodiment of the TX 102 depicted in FIG. 1 and/or the TX 502 depicted in FIG. 5. In an example, the RXs 1004-1, 1004-2 depicted in FIG. 10 may be an embodiment of the RX 104 depicted in FIG. 1 and/or the RX 504 depicted in FIG. 5. Each of the first repeater 1060-1 and the second repeater 1060-2 may be fully or partially implemented as an integrated circuit (IC) device. For example, the transmitter (TX) 1002-1 and the receiver (RX) 1004-1 are located in the same substrate and the repeater 1060-1 is implemented as one IC device (e.g., a system on chip (SOC)) for bi-directional communications. In another example, the transmitter (TX) 1002-2 and the receiver (RX) 1004-2 are located in the same substrate and the repeater 1060-2 is implemented as one IC device (e.g., a system on chip (SOC)) for bi-directional communications. Although the depicted repeater system 1000 is shown in FIG. 10 with certain components and described with certain functionality herein, other embodiments of the repeater system 1000 may include fewer or more components to implement the same, less, or more functionality. In addition, although the repeater system 1000 is shown in FIG. 10 as being connected in a certain topology, the network topology of the repeater system 1000 is not limited to the topology shown in FIG. 10. The repeater system 1000 may be a wired communications system or a wireless communications system.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A repeater comprising:
an encoder configured to generate a plurality of symbols based on data from a plurality of data sources; and
a transmitter modem configured to transmit information in the symbols over a repeater channel.

2. The repeater of claim 1, wherein the data sources comprise a latency critical data source.

3. The repeater of claim 1, wherein the data sources comprise a first data source with a first data speed and a second data source with a second data speed, and wherein the first data speed is different from the second data speed.

4. The repeater of claim 1, further comprising a framer configured to generate a plurality of frames based on the symbols, wherein the transmitter modem is further configured to transmit the frames over the repeater channel.

5. The repeater of claim 1, wherein the repeater comprises an embedded Universal Serial Bus (eUSB) repeater.

6. The repeater of claim 1, where the symbols have a size of four bits or twelve bits.

7. The repeater of claim 1, where the symbols comprise a burst symbol that is composed of a plurality of four-bit symbols.

8. The repeater of claim 1, where the symbols comprise a clock adjustment symbol or a bus state symbol.

9. The repeater of claim 1, where the symbols comprise a non-repeating (NREP) symbol, a start of packet (SOP) symbol, an extra data (XDAT) symbol, or a non-action (NOP) symbol.

10. An embedded Universal Serial Bus (eUSB) repeater comprising:
an encoder configured to generate a plurality of symbols based on data from a plurality of data sources, wherein the data sources comprise a latency critical data source, a first data source with a first data speed, and a second data source with a second data speed, and wherein the first data speed is different from the second data speed; and
a transmitter modem configured to transmit information in the symbols over a repeater channel.

11. The eUSB repeater of claim 10, further comprising a framer configured to generate a plurality of frames based on the symbols, wherein the transmitter modem is further configured to transmit the frames over the repeater channel.

12. The eUSB repeater of claim 10, where the symbols have a size of four bits or twelve bits.

13. The eUSB repeater of claim 10, where the symbols comprise a burst symbol that is composed of a plurality of four-bit symbols.

14. The eUSB repeater of claim 10, where the symbols comprise a clock adjustment symbol or a bus state symbol.

15. The eUSB repeater of claim 10, where the symbols comprise a non-repeating (NREP) symbol, a start of packet (SOP) symbol, an extra data (XDAT) symbol, or a non-action (NOP) symbol.

16. A method of operating a repeater, the method comprising:
using an encoder, generating a plurality of symbols based on data from a plurality of data sources; and
using a transmitter modem, transmitting information in the symbols over a repeater channel.

17. The method of claim 16, wherein the data sources comprise a latency critical data source.

18. The method of claim 16, wherein the data sources comprise a first data source with a first data speed and a second data source with a second data speed, and wherein the first data speed is different from the second data speed.

19. The method of claim 16, further comprising generating a plurality of frames based on the symbols, wherein transmitting the information in the symbols over the repeater channel comprises transmitting the frames over the repeater channel.

20. The method of claim 16, where the symbols comprise a non-repeating (NREP) symbol, a start of packet (SOP) symbol, an extra data (XDAT) symbol, or a non-action (NOP) symbol.
